(19) United States
(12) Patent Application Publication
(10) Pub. No.: US 2002/0180807 A1
(43) Pub. Date: Dec. 5, 2002

(54) One-touch URL or program selection

(75) Inventors: Thomas James Dubil, Morgan Hill, CA (US); Jeffrey Newl Kessler, Sunnyvale, CA (US)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 09/872,715

(22) Filed: Jun. 1, 2001

(51) Int. Cl. G06F 3/00; G06F 13/00

(52) U.S. Cl. 345/840; 345/810

(57) ABSTRACT

A remote control has a button to gain access to a URL on the Internet. In an example embodiment, a remote control apparatus comprises a user-interface programmable to retrieve content from the Internet. In a particular application, the remote control would be part of a system comprising a STB box connected to a network. The remote control is coupled to the STB, wherein the STB stores the predetermined URL. The user may retrieve the predetermined URL by actuating a shortcut key on the remote. This URL may be programmed by the user or by a third party in response to a user profile.

### FIELD OF INVENTION

The present invention is generally directed toward the obtaining of content information. In particular, the present invention relates to a method of selecting content through a network via a Uniform Resource Locator (URL).

### BACKGROUND OF INVENTION

The ability for the user to interact with the myriad of information available poses a challenge. It is not uncommon for one to obtain information from a printed source such as books and newspapers, physical electronic media such as CDs, DVDs, magnetic disks, network based media such as Internet-based content, and wireless media such as broadcast radio and television, and wired/wireless communication devices such as phones. Each of these media has a particular way by which the user extracts information. Efforts to meet the challenge of interacting with different media formats may be found in U.S. patent application 09/568,932 filed (Attorney docket US 000106) on May 11, 2000, titled, “Electronic Content Guide Renders Content Resources Transparent,” of Yevgeniy E. Shteyn et al., incorporated herein by reference.

For example, reading the newspaper is straightforward. Reading the same newspaper broadcast from the Internet involves looking up the URL (Uniform Resource Locator) in the Browser and downloading the content. Oftentimes, the URL is quite lengthy and difficult to remember. One errant keystroke and the user may fail in locating the particular newspaper. Of course, search engines enable the user to locate the newspaper's web address. However, time and frustration may often be expended needlessly.

This is particularly true if the user is obtaining information from an entertainment context. Information comes from a variety of sources. The user may view or listen to the information on his audio/visual monitor. This monitor is coupled with a variety of information sources such as a CD player, DVD player, a cable or satellite set top box (STB), broadcast television receiver, and a modem with an Internet connection, respectively. User interface devices in the form of a remote control device provide access to the first four example devices in a familiar format. However, the URL of Internet content is not so familiar and hence, the content associated with the URL is not as accessible.

### SUMMARY OF INVENTION

There exists a need for keeping track of a URL in a remote control. The user merely has to select a button or activate another user-input on his/her remote to gain access to the content information of, or the Web Site represented by, the URL as he would conventionally do with any other apparatus of his/her home equipment.

The present invention is exemplified in a number of implementations, two of which are summarized below.A remote control apparatus in the invention comprises a user-interface programmable to retrieve content from the Internet. The user-interface, e.g., a button on the remote, is programmed to gain access to at least one URL. An additional feature of the remote control apparatus is that the button's programming may be verified by a feedback mechanism comprising audio, visual, or tactile stimulation.

In another example embodiment, a remote control system has access to the Internet or another data network via, e.g., an STB. The system comprises a remote control device having at least one button user-programmable to seek out a predetermined URL. The remote control communicates with the STB. The STB stores the predetermined URL, e.g., in a look-up table (LUT). The LUT uses as an input a command from the remote and the command's association with the button. The LUT has an output, the pre-determined URL. Another feature of this embodiment is that the pre-determined URL may be programmed or re-programmed by user-interaction with the STB or by third party interaction with the STB, e.g. from the service provider or network operator. Such a third party interaction may be in response to a user-profile.

Accordingly, the remote or apparatus with Internet access and a browser is programmable, preferably re-programmable by the user. This lets the user have access to Web Sites by simply pressing a button on the remote.

The above summaries of the present invention are not intended to represent each disclosed embodiment, or every aspect, of the present invention. Other aspects and example embodiments are provided in the figures and the detailed description that follows.

### BRIEF DESCRIPTION OF THE DRAWINGS

The invention may be more completely understood in consideration of the following detailed description of various embodiments of the invention in connection with the accompanying drawing, in which:

FIG. 1 outlines the process of a user in programming one or more buttons on a remote to gain access to a predetermined channel according to an embodiment of the present invention;

FIG. 2 outlines the process of a Set Top Box vendor programming the shortcut key of the remote; and

FIG. 3 is a block diagram of an apparatus with Internet access controllable via the remote according to an embodiment of the present invention.

While the invention is susceptible to various modifications and alternative forms, specific embodiments thereof have been shown by way of example in the drawing and will herein be described in detail.

### DETAILED DESCRIPTION

The present invention has been found to be useful and advantageous in connection with providing a simplified way of gaining access to a web site. In an example embodiment, the invention allows the end user of a set-top box or a party with access to the set-top box's software to map a button, or several buttons, on a remote control. These buttons may be defined to select channels or URLs. These buttons may come pre-defined via software in the set-top box and later re-defined by the end user or party with access to the set-top box's software.

In an example embodiment according to the present invention, the remote control used for controlling the set-top box and often, other audio/video appliances has a dedicated button and communication command that the remote transmit to the set-top box. Within the set-top box, there is a software table (look-up table) which maps the transmitted command to a change in the state of the set-top box.

The above action may be re-defined by the end user with access to the set-top box's software allowing the storage into the table other actions including directly gaining access to a channel or URL.

The changing of information in the look-up table is accomplished in another example embodiment according to the present invention. The user places the set-top box into a desired state. The box is tuned to a particular channel or taken to a preferred URL. Through a command from the remote, the set-top box initiates storing this state change into the lookup table. This state change is programmed as associated with a button on the remote. Note that the remote or the STB can be programmed to gain access to a specific Web site as defined by the stored URL. For example, the remote can issue a fixed command that gets translated into the action of gaining access to a Web site whose URL has been reprogrammably stored in the STB. In another example, the URL, or information representative of it, has been stored in the remote. In the latter case, one needs a bi-directional link between the remote and STB. Later when the button on the remote is pushed, the set-top box returns to the desired state now stored in the lookup table.

In a specific embodiment, the invention relates to an STB and a remote control device. The remote control device has a specific button for causing the STB to retrieve a web page from a specific web address. The web address is programmable or re-programmable, e.g., by the user. The STB stores a look-up table that maps the remote's command, stored under the button, to the web address defined by the user. The defined web address is programmed or reprogrammed through a simple user-interaction with the STB. Alternatively, a third party can pre-define or reprogram the look-up table via the STB, e.g., as a value-added service based on user-profiling. A third party can re-program the look-up table dynamically dependent on a TV program currently being received by the consumer in order to give the user access to supplementary info within the program's context (e.g., advertisements in an e-commerce context). The supplementary information is communicated to the user via, e.g., the remote, his/her PC, or another suitable rendering device. Alternatively, one or more buttons are automatically programmed for most-frequently used URL's.

The remote control device comprises, e.g., the PRONTO™ manufactured by Philips Electronics. The PRONTO™ is a universal programmable remote control with an LCD touch screen. The user can program the graphical user-interface (GUI) of the PRONTO™ to organize the control functionalities as icons allocated to different pages. The icons serve as buttons to initiate the transmission of an IR or RF command to an IR or RF controllable piece of equipment. One or more icons can be reserved for a command that controls, e.g., an STB to retrieve one or more specific electronic documents from the data network. The command may contain data representative of the document's URL. For example, the command comprises tags, e.g., in XML, that are interpreted by the STB to process the data in the command as a URL.

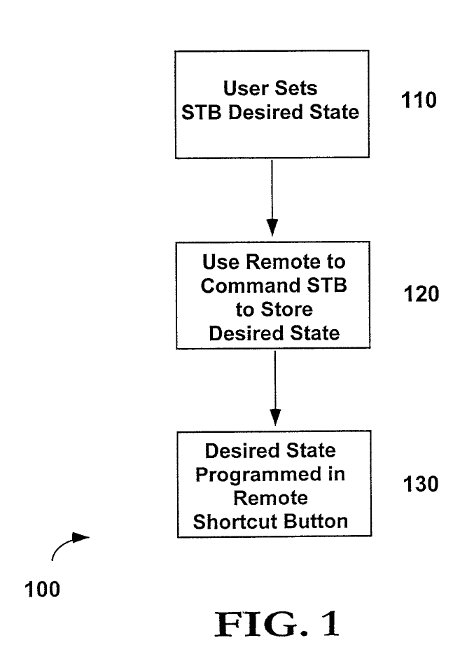

Refer to FIG. 1. The steps 100 outline a procedure for defining a desired state in a remote control. The user sets the desired state 110 in the STB. The user has the remote command the STB to store the desired state 120. The desired state 130 is programmed in the remote's shortcut button.

In another example embodiment, a company (who often provides a service) via the set-top box has access via a network connection. Through the network connection, the company modifies the lookup table replacing a specific state change instruction therein with a new specific state change instruction. Other methods may be used to update the lookup table as well.

Incorporated herein by reference are the following documents:

U.S. patent application Ser. No. 09/349,676 (attorney docket PHA 23,681) filed on Jul. 8, 1999 titled, “After Sales Customization specified by Retailer Acts as Incentive,” of Kristen D. Ondeck. This document relates to a machine-implemented method of doing business that enables to stimulate commercial activities. According to the method a customer is enabled to notify a specific party, e.g., a manufacturer, importer, or distributor, or a specialized service provider, of a specific commercial activity wherein he or she is or was involved. Upon being notified, the party enables customizing, via a data network such as the Internet, the equipment of the customer as associated with the commercial activity. For example, the specific activity relates to sales of merchandise via a retailer, and the customer notifies the specific party of the purchase of the merchandise from the retailer. When the party has been notified, it enables customizing Internet-enabled or upgradeable electronic equipment of the customer, via the Internet, as associated with the specific retailer from whom the merchandise was purchased. For example, the merchandise is related to the Internet (software application or hardware device) and the customer has purchased it to make it part of his/her Internet-enabled equipment. The merchandise is enabled to be customized via the Internet, preferably according to specifications from the retailer, and also according to input as to, e.g., the intended usage, supplied by the customer at the time when the specific party was notified.

U.S. Ser. No. 09/519,546 (attorney docket US 000014) filed Mar. 6, 2000 for Erik Ekkel et al., for PERSONALIZING CE EQUIPMENT CONFIGURATION AT SERVER VIA WEB-ENABLED DEVICE. This document relates to facilitating the configuring of CE equipment by the consumer by means of delegating the configuring to an application server on the Internet. The consumer enters his/her preferences in a specific interactive Web page through a suitable user-interface of an Internet-enabled device, such as a PC or set-top box or digital cellular phone. The application server generates the control data based on the preferences entered and downloads the control data to the CE equipment itself or to the Internet-enabled device.

U.S. Ser. No. 09/635,549 (attorney docket US 000209) filed Aug. 10, 2000 for Eugene Shteyn for TOPICAL SERVICE PROVIDES CONTEXT INFORMATION FOR A HOME NETWORK. This document relates to a consumer apparatus that is made an intuitive component of a user-interface to a topical server. A specific user-interaction with the apparatus or its proxy on the home network causes a request to be sent to a specific server on the Internet based on a predefined URL. The home network receives a particular web page from the server with content information dedicated to the context of use of the apparatus.

U.S. Ser. No. 09/653,784 (attorney docket US 000220) filed Sep. 1, 2000 for Frank Caris et al., for STB CONNECTS REMOTE TO WEBSITE FOR CUSTOMIZED CODE DOWNLOADS. This patent document relates to marketing a set top box (STB) together with a programmable remote. The remote has a dedicated button to connect the STB to a specific server on the Internet. The consumer can notify the server of his/her other CE equipment, which he/she desires to be controllable through the same remote as the one that came with the STB. The server downloads to the STB data representative of the relevant control codes. The STB is provided with means to program the remote with these codes. In return the server has obtained detailed and accurate information about this consumer's equipment. A reliable customer base can thus be built for streamlining Help Desk operations.

U.S. Ser. No. 09/686,572 (attorney docket US 000183) filed Oct. 10, 2000 for Thomas Dubil et al., for CONTROL CODES FOR PROGRAMMABLE REMOTE SUPPLIED IN XML FORMAT. This patent document relates to an Internet service that makes control codes available for use on a programmable universal remote. The remote controls CE equipment through IR or RF commands. A server supplies the control codes as XML data that gets processed at the receiver's set top box or PC, or the remote itself, for being properly installed on the remote.

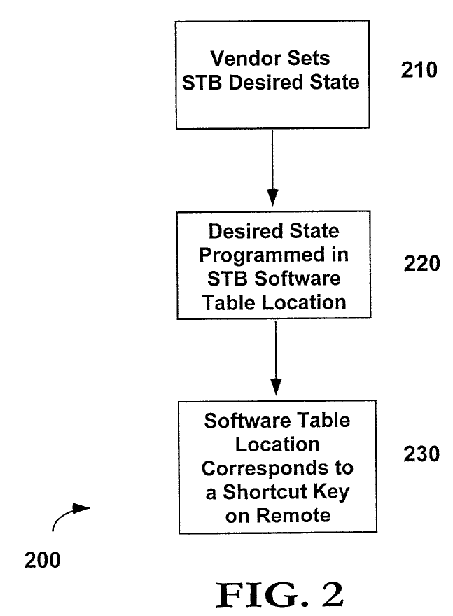

Refer to FIG. 2. In another example embodiment according to the present invention, a vendor initiates the process of programming the remote control's shortcut key 200. The vendor sets the STB to a desired state 210. For example, this may be a TV channel or URL. The desired state is programmed in an STB software table location 220. The software table location 220 corresponds to a shortcut key on the remote control 230. This shortcut key may be a pre-defined key analogous to the “Home” button on a browser. The channel to which this key points is determined by the vendor's wish to direct the user to a particular channel based on information gathered about the user, time or day, entertainment programming, etc.

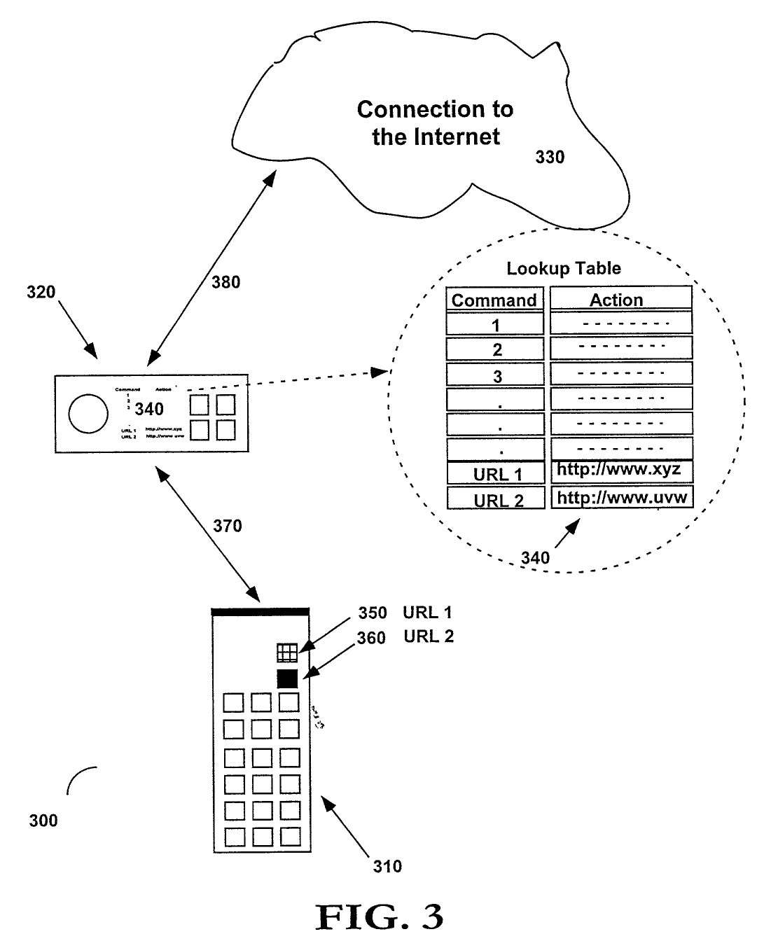

The programming processes outlined in FIG. 1 and FIG. 2 may be implemented in a STB and its corresponding remote control as shown in FIG. 3 according to the present invention. An example remote control 310 and a set top box 320 communicate with one another through a link established at 370. Typically, such a link is an infrared interface. However, other interfaces may include radio transmission or wired connection. The remote control 310 commands the set top box 320. Additionally, the set top box 320 may have a connection 380 to the outside world via the Internet 330. The connection 380 may be through a cable television provider or Internet service provider (ISP). Within the set top box 320 is a lookup table 340 that stores the user desired state 110 (or a vendor desired state 210) by using the remote to command the STB 320 to store the desired state 120. In the example remote 310, a key 350 and a key 360 are programmable to store URL1 and URL2, respectively. A vendor may gain access to the STB via the Internet 330 and the STB's connection 380. The lookup table 340 stores the URL 1 and URL 2 commands. These commands correspond to the actions enumerated. For example, URL 1 is first web address and URL 2 is second web address. Although the example remote control depicted here has two URL buttons, such a remote may have any number of such buttons. Note that these URLs may refer to a filename in local or network storage. For example, the user may gain access to a locally stored document within the STB's memory storage. Other commands and actions in the lookup table may refer to particular entertainment channels as found on a cable television network (CATV), for example.

When programming of the URL 1 and URL 2 buttons 350 and 360 is complete, the remote may be equipped to respond, with a feedback mechanism, notifying the user that programming has been successful. For example, the URL buttons may be illuminated to change from one color to another indicating a programmed state. The remote control may emit a sound indicating successfully programming. In a low-light environment having extraneous noise, the remote may also be equipped to provide a tactile signal, such as vibration.

Also note that buttons in the context of the present invention may be physical buttons on the remote itself or graphical representations of buttons on a remote having a touch screen display. These graphical representations may change form from a state showing blank to a state indicating that a given URL has been programmed. For example, an icon may be displayed that is trademark of the URL or an entertainment channel. Additionally, knobs having multiple settings may be present. For example, the URL 1 and URL 2 buttons in the example remote may be two settings a knob may be rotated to select.

The term “Internet” as used above applies to other data networks as well, e.g., AOL for the purpose of this invention.

The electronic document may comprise a file streamed to the end-user via the data network. For example, user-interaction with the remote control device causes the user's equipment to retrieve, e.g., live audio broadcast on the Internet. The button or other user-input at the remote then serves as a selection mechanism to select a specific Internet radio broadcast station.

An aspect of the invention resides at representing URLs as bookmarks at the end-user's remote control device. The URLs may be stored in the remote or at the equipment with network access. Local software or a remote third party may update the URLs within the context of providing a certain service (e.g., Internet audio programs or Internet video programs). By means of dynamically re-programming the URLs in this case, e.g., under timestamp control or by sequencing through a list in response to user-interaction, the user is enabled to automatically browse the electronic documents.

While the present invention has been described with reference to several particular example embodiments, those skilled in the art will recognize that many changes may be made thereto without departing from the spirit and scope of the present invention, which is set forth in the following claims.

What is claimed is:

1. A remote control apparatus comprising:
a user interface to enable a user to initiate retrieval of an electronic document from a data network, the apparatus being programmable withrespect to a URL of the document.

2. The remote control apparatus of claim 1 wherein the user interface comprises a button for initiating the retrieval.

3. The remote control apparatus of claim 1 wherein the programming is verifiable by a feedback mechanism comprising at least one of the following modalities: audio, visual, tactile.

4. A data processing system for access to a data network, the system comprising:
a piece of equipment with network access;
a remote control apparatus to initiate accessing a document on the network with a pre-determined URL upon user-actuation, via the piece of equipment, wherein the piece of equipment stores the pre-determined URL, and wherein the piece of equipment is programmable with regard to the pre-determined URL.

5. The system of claim 4 wherein the predetermined URL is programmed by at least one of the following: user-interaction with the STB, third-party interaction with the STB.

6. The system of claim 5 wherein the third-party interaction is based on a user-profile.

7. Software for being installed onto at least a remote control apparatus or a piece of a data network access equipment, wherein the software renders the apparatus operative to select at least one URL with a shortcut key, and wherein the URL is programmable.

8. A service supplied in a client-server configuration, wherein:
the server provides user-access to a list of information items; and
the client is enabled to interact with the server and make selections, the selections being programmable on at least one button of a client interface, wherein the client interface comprises:
network access to the server; and
at least one button programmable to initiate accessing a document on the network with a pre-determined URL upon user-actuation, via the server, wherein the server stores the pre-determined URL.

9. A remote control device having access to a data network, the remote control having a programmable user-interface to command a piece of equipment to retrieve a document on the data network via a URL.

10. A piece of equipment linked to a data network, the piece of equipment programmable to retrieve a document from the data network via a URL upon receipt of a command from a remote control device having a user-interface.
